(19) United States
(12) Patent Application Publication
(10) Pub. No.: US 2004/0252493 A1
(43) Pub. Date: Dec. 16, 2004

(54) Mounting holster for releasable attachment of an object to a target structure

(76) Inventor: Donald G. Sheffield, Frederick, MD (US)

Correspondence Address: Larson & Associates, P.C., 221 East Church Street, Frederick, MD, 21701-5405, US

(21) Appl. No.: 10/459,151

(22) Filed: Jun. 11, 2003

(51) Int. Cl. F21L 4/00; B60Q 1/00

(52) U.S. Cl. 362/190; 362/500; 362/253

(57) ABSTRACT

A holster assembly for releasable attachment of an object, such as a light source, to a target structure. The holster assembly has a barrel portion operable to receive the object within it and an attachment portion coupled to the barrel portion for releasable attachment of the holster to the target structure through a latching mechanism. The assembly is attached to the target structure upon activation of the latching mechanism and released from the target structure upon deactivation of the latching mechanism. The barrel portion may optionally have a release mechanism operable to release the object seated within it in which case the object may be released from the barrel portion upon activation of the release mechanism of the barrel portion.

### FIELD OF THE INVENTION

The present invention relates generally to attachment mechanisms and more specifically to an improved mechanisms for releasably attaching an object to at least a semi-rigid target structure.

### BACKGROUND OF THE INVENTION

There are many instances where it is desirable to at least temporarily attach an object, particularly a small object, to at least a semi-rigid structure. Such is the case, for instance, when it is desirable to attach a light source to the spokes of the wheel of a bicycle for visibility and decorative purposes, although there are countless other situations in which it is desirable to attach objects to a pole, spoke, tubing, or other generally elongated surface, whether it be cylindrical or have edges. It would be desirable that an approach for temporary attachment and then release of an object to a target structure provide for releasable attachment of the object and for quick change out of the object if that should become desirable, such as upon faulty operation of the device.

### BRIEF DESCRIPTION OF THE DRAWINGS

The novel features believed characteristic of the invention are set forth in the claims. The invention itself, however, as well as a preferred mode of use, and further objects and advantages thereof, will best be understood by reference to the following detailed description of an illustrative embodiment when read in conjunction with the accompanying drawings, wherein:

FIG. 1 is a perspective view of an assembly for attaching an object to a target structure in accordance with certain embodiments of the present invention.

FIG. 2 is an exploded view of the assembly of FIG. 1 in accordance with certain embodiments of the present invention.

FIGS. 3-4 are side views of a first type of hinged attachment portion of a holster in accordance with certain embodiments of the present invention.

FIGS. 5-7 are side views of a second type of hinged attachment portion of a holster in accordance with certain embodiments of the present invention.

FIGS. 8-9 are side views of a third type of hinged attachment portion of a holster in accordance with certain embodiments of the present invention.

FIGS. 10-11 are views of an exemplary light source in accordance with certain embodiments of the present invention.

### DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description, below, like reference numerals are used to describe the same, similar or corresponding parts in the several views of the drawing.

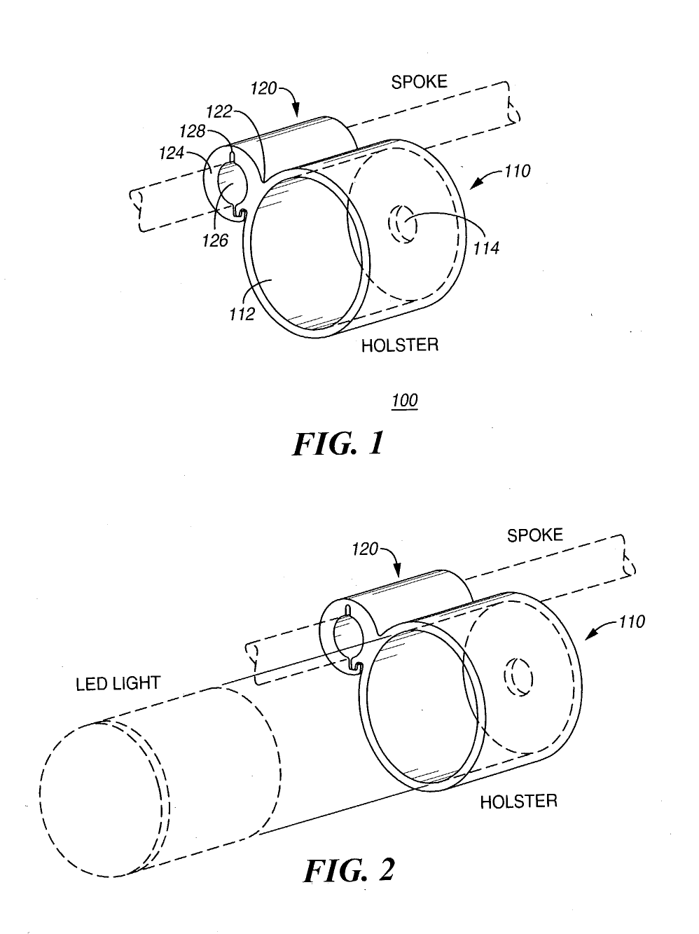

Referring now to FIG. 1, a perspective view 100 of a holster in functional relation to a target structure, at least a semi-rigid structure capable of supporting the attachment of a holster containing an object to be mounted to the target structure via the holster, in accordance with certain embodiments of the present invention is shown. Examples of a target structure may include a cylindrical spoke, pole or tubing, such as may be found on a bicycle or motorcycle tire or wheel, or a string of a kite, for instance. And, the material and size of the target structure may change without departing from the spirit and scope of the present invention and the means for attaching the holster would accordingly change to accommodate the size and shape of the target structure. The holster has a barrel portion 110 and an attachment portion 120, which may be integrally formed of one piece of material if so desired. The holster may be made of any material, such as a plastic, suitable for accommodating its attachment and release characteristics as will be described. The holster may be waterproof if so desired.

The barrel portion 110 is shaped so as to receive an object to be mounted to the target structure via the holster into cavity 112 of the barrel. The object for purposes of illustration may be a light source, such as a self-contained light emitting diode (LED) having its own battery source to be attached to bicycle spokes, but it may be any object suitable for being releasable attached to the target structure via the holster. The barrel portion 110 is sized relative to the light source to provide a snug fit, so that as the light source is inserted into cavity 112 air suction is created that tends to hold the light source in place in the cavity until it is released. The barrel portion 110 may optionally be characterized by a quick release mechanism for easily and quickly removing a light source that is seated into it. As illustrated in the drawing, the quick release mechanism may be a small through-hole or air hole 114 located in a bottom surface of the barrel portion. The through-hole will accommodate the point of a pen or other suitable object to make contact with the bottom of a seated light source. Pushing upward on the base of the light source with the object through said through-hole breaks the suction holding the light source securely in the holster barrel portion, thereby allowing the light source to be easily removed.

The attachment portion 120 of the holster provides the mechanism for easily, readily, and on-demand attaching and releasing the holster to and from the target structure. In the embodiment shown in FIGS. 1-4, the attachment portion uses a “living” hinge arrangement in which a first hinge portion 122 and a second hinge portion 124 are in functional communication with each other about a hinge point 128. When the two portions of the attachment portion 120 are brought together in the closed position shown in FIGS. 1 and 2, they form a cavity 126 therethrough that accommodates the target structure to which the holster is attached.

The ability of the first and second hinge portions 122, 124 to controlled to open and close as desired without destroying or denigrating the latching ability of the attachment portion 120 provides an advantage. The holster may be attached and/or removed to the target structure has many times as desired. This in turn provides flexibility in the reusability of the holster in many different locations of the same or different target structures. Thus, the term “living” hinge.

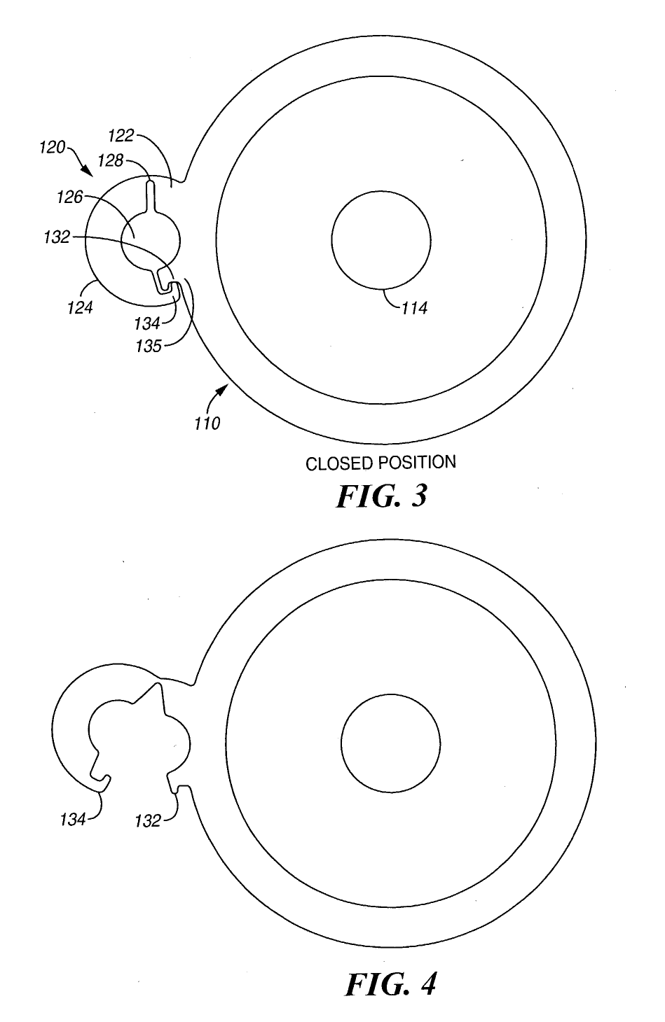

Referring now to FIGS. 3 and 4, the operation of the attachment portion as a hinge is illustrated. In FIG. 3, the hinge is shown in its closed, secured position. First and second hinge portions 122, 124 each have corresponding latching portions 132, 134, respectively, which when pushed against each other create a releasable latch 135 that operates to keep the holster secured about the target structure until opened or released. Latching portions 132, 134 enjoy complementary shapes that when pressed together mate to form a secure latch. It is understood that the shape of the first and second latching portions 132, 134 may be changed as desired so long as when the first and second portions 122, 124 are brought together, by pressing or otherwise, they form a functional yet releasably latch that functions to keep the attachment portion 120 about the target object until action is taken to release the holster from the target structure.

In the exemplary embodiment of FIGS. 3-4, the latching portion 132 of first portion 122 is an “L” shape and latching portion 134 of first portion 124 is a “U” shape. When second portion 124 is pressed towards first portion 122, U-shaped latching portion 134 makes contact with L-shaped latching portion 132 and slides over it to cup around latching portion 132 until it snaps in place over the lip of latching portion 132, thus achieving the closed, attached position shown in FIG. 3. The hinge is not permanently closed, however, and may be opened, shown in FIG. 4, by employing the proper release action. In this embodiment, the hinge is opened by forcing the outside of the U-shape of latching portion 134 away and down from latching portion 132, thereby opening the latch. It is noted that first portion 122 may be stationary with respect to barrel portion 110 or it may move in a hinged fashion like second portion 124.

The holster will stay in releasable contact with the target structure in this manner until the hinge is opened and it will do so in a reliable way, as described. After snapping the holster to the target structure, it has been shown that it will stay affixed to the target structure while the target structure is moving at high speeds, at more than 70 miles per hour, for example. The attachment portion 120 of the holster may be opened and closed with respect to target structures as often as desired. The material from which the holster is made should be strong enough at the hinge point 128 and in the first and second portions 122 and 124 to accommodate the desired usage.

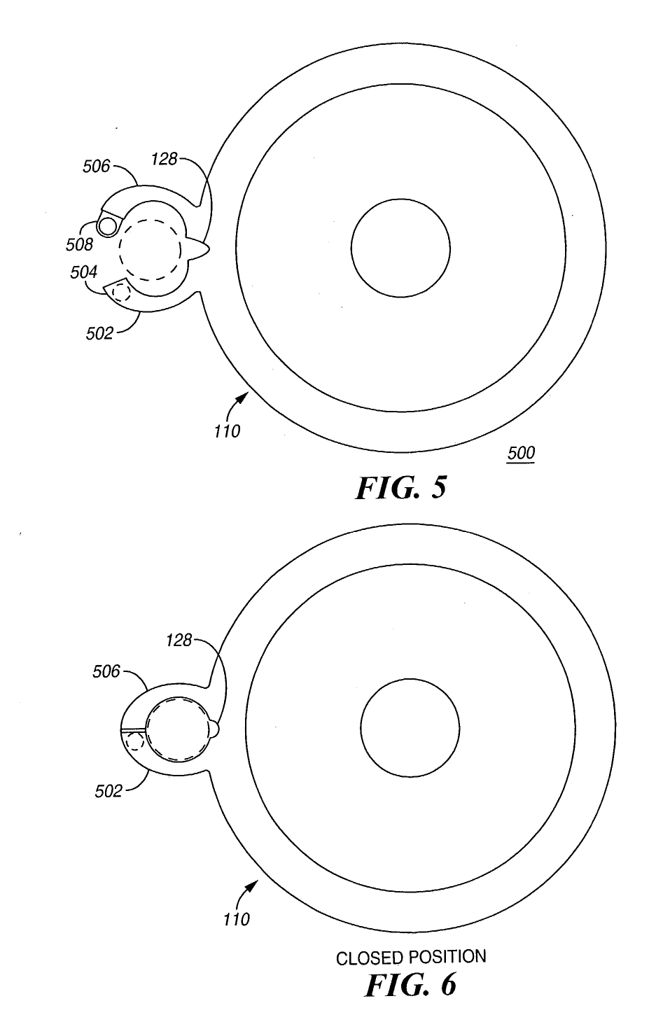

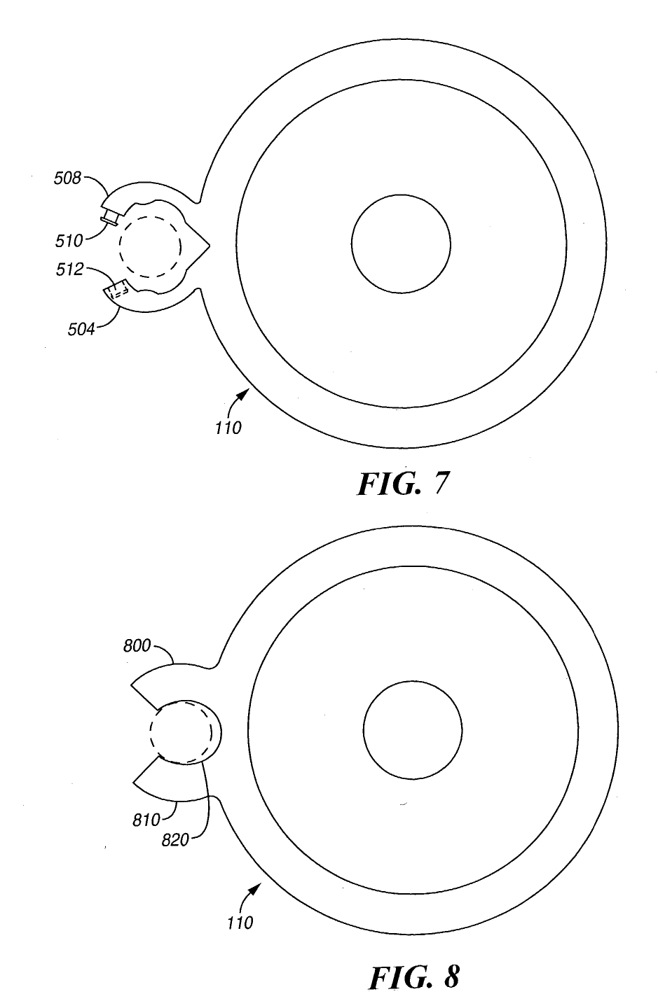

Referring now to FIG. 5-6, another exemplary holster in accordance with certain embodiments of the present invention is illustrated. FIG. 5 illustrates the open position of the holster while FIG. 6 illustrates the closed position of the holster. In FIG. 5, it can be seen that while barrel portion 110 is similar in configuration as in FIGS. 1-4, the attachment portion is different. First hinge portion 502 has a latching portion 504 having a female slot capable of accommodating the counterpart male shape of latching portion 508 of second hinge portion 506. When the first and second hinge portions 502, 506 are pressed together male latching portion 508 is inserted into female latching portion 504 to achieve the closed position closed in FIG. 6. As illustrated in FIG. 7, male latching portion 508 may have a slightly protruding ridge shape 510 tending to retain it under a corresponding lip portion 512 formed inside the cavity of female latching part 504.

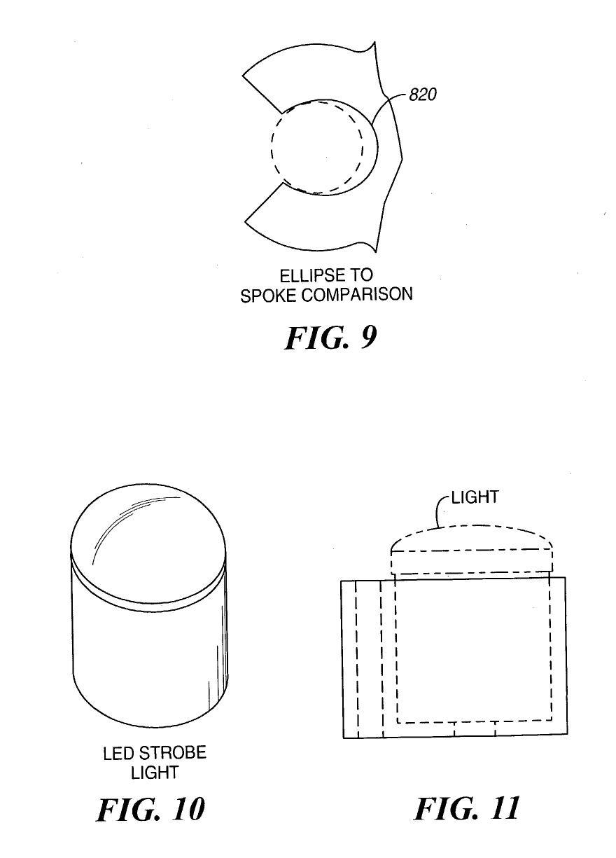

Referring now FIGS. 8-9, yet another exemplary holster arrangement in accordance with certain embodiments of the present invention is illustrated. In FIG. 8, the barrel portion of holster 110 may be arranged as described above. Attachment portion 800, however, does not employ a hinge arrangement. Attachment portion 800 has first and second portions 810 framing a cavity 820 therebetween suitable for accommodating the insertion of the target object, such as a tire spoke. The holster is attached to the target structure by pressing the portions 810 of the holster over and around the target structure. As illustrated in FIG. 9, the shape of cavity 820 may be different than the shape of the target structure over which it will be pressed. In the drawing, an elliptical shape of cavity 820 in relation to a round or cylindrical shape of the target structure enhances the fitting and removal of the holster around the target structure. The elliptical shape facilitates the adjustment of the holster to a variety of generally cylindrical different target structure shapes and allows it to flex and conform to those different shapes and range of sizes.

The light source may be any light source desired to be fitted within the holster and may have its own source of power. LED (light emitting diode) lights are particularly suited for insertion in barrel portion 110 and may provide enhanced safety to riders of bicycles, motorcycles, etc. to which the holster is attached. Flashing LEDs, with a variety of different colors, may provide a visually stimulating effect as well as the safety enhancement discussed above. Referring now to FIG. 10, an exemplary light source, in the form of an LED strobe light is shown. In FIG. 11, the relation of such an LED strobe light to a holster in accordance with certain embodiments of the present invention can be seen.

While the invention has been particularly shown and described with reference to a preferred embodiment, it will be understood by those skilled in the art that various changes in form and detail may be made therein without departing from the spirit and scope of the invention. For example, it is noted that the shape of the spoke or other target structure may vary without departing from the spirit and scope of the invention. The spoke is generally cylindrical, in the manner commonly known, but it may have sides or a less than circular shape if so desired. The hole of the attachment portion 120 of the holster may be accordingly changed to accommodate the new shape of the target structure.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A holster suitable for mounting an object housed in the holster to a target structure to which the holster may be releasably attached, comprising:
a barrel portion operable to receive the object within it, wherein the barrel portion comprises a release mechanism operable to release the object seated within it; and
an attachment portion coupled to the barrel portion for attachment of the holster to the target structure.

2. The holster of claim 1, wherein the release mechanism is an air hole extending through a floor portion of barrel portion upon which a bottom surface of the object is seated.

3. The holster of claim 2, wherein release of the object from the barrel portion is accomplished by exerting a force through the air hole upon the bottom surface of the object.

4. A holster suitable for mounting an object housed in the holster to a target structure to which the holster may be releasably attached, comprising:
a barrel portion operable to receive the object within it; and
an attachment portion coupled to the barrel portion, wherein the attachment portion is operable to permit the holster to be releasably attached to the target structure.

5. The holster of claim 4, wherein the attachment portion further comprises:
a first hinge portion;
a second hinge portion coupled to the first hinge portion about a hinge point; and
a latching mechanism that causes the first and second hinge portions to latch together in a closed position when said first and second hinge portions are brought together.

6. The holster of claim 5, wherein the latching mechanism further comprises:
a first latch portion of the first hinge portion;
a second latch portion of the second hinge portion;
wherein said first and second latch portions are complementary in shape to permit the first and second latch portions to latch together in a closed position of the attachment portion when brought together.

7. The holster of claim 6, wherein the first latch portion has a u-shape and the second latch portion has an 1 shape, such that when the first latch portion is pressed against the second latch portion, the u shape of the first latch portion presses over and surrounds the second latch portion, an outside portion of the u shape latching over the 1 shape of the second latch portion.

8. The holster of claim 7, wherein attachment portion is releasably latched in the closed position and the latch formed in the closed position may be opened by forcing the u shape of the first latch portion open to break the latch with the 1 shape of the second latch portion.

9. The holster of claim 6, wherein the first latch portion is a male portion of the latching mechanism and the second latch portion is a complementary female portion of the latching mechanism.

10. The holster of claim 9, wherein pressing the first and second hinge portions of the attachment portion together forces the male portion into the female portion and latches said male and female portions together.

11. The holster of claim 10, wherein the male portion further comprises a ridge portion adjacent the end of said male portion and the female portion has a corresponding lip portion adjacent the end of said female portion, and
wherein when the male portion is pressed into the female portion, the lip portion of said female portion operates to retain the ridge portion of said male portion within said female portion.

12. The holster of claim 4, wherein the barrel portion comprises a release mechanism operable to release the object seated within it.

13. The holster of claim 12, wherein the release mechanism is an air hole extending through a floor portion of barrel portion upon which a bottom surface of the object is seated.

14. The holster of claim 13, wherein release of the object from the barrel portion is accomplished by exerting a force through the air hole upon the bottom surface of the object.

15. An assembly for releasably mounting a light source to a target structure, comprising:
a holster suitable for housing the light source and releasably attaching the light source to the target structure, comprising:
a barrel portion operable to receive the object within it, wherein the barrel portion comprises a release mechanism operable to release the object seated within it; and
an attachment portion coupled to the barrel portion for releasable attachment of the holster to the target structure through a latching mechanism, and
the light source seated within the barrel portion of the holster,
wherein the light source is released from the barrel portion upon activation of the release mechanism of the barrel portion, and wherein the assembly light source is attached to the target structure upon activation of the latching mechanism and released from the target structure upon deactivation of the latching mechanism.

16. The holster of claim 15, wherein the latching mechanism further comprises:
a first latch portion of the first hinge portion;
a second latch portion of the second hinge portion;
wherein said first and second latch portions are complementary in shape to permit the first and second latch portions to latch together in a closed position of the attachment portion when brought together.

17. The holster of claim 16, wherein the first latch portion has a u-shape and the second latch portion has an 1 shape, such that when the first latch portion is pressed against the second latch portion, the u shape of the first latch portion presses over and surrounds the second latch portion, an outside portion of the u shape latching over the 1 shape of the second latch portion.

18. The holster of claim 17, wherein attachment portion is releasably latched in the closed position and the latch formed in the closed position may be opened by forcing the u shape of the first latch portion open to break the latch with the 1 shape of the second latch portion.

19. The holster of claim 16, wherein the first latch portion is a male portion of the latching mechanism and the second latch portion is a complementary female portion of the latching mechanism.

20. The holster of claim 19, wherein pressing the first and second hinge portions of the attachment portion together forces the male portion into the female portion and latches said male and female portions together.

21. The holster of claim 20, wherein the male portion further comprises a ridge portion adjacent the end of said male portion and the female portion has a corresponding lip portion adjacent the end of said female portion, and
wherein when the male portion is pressed into the female portion, the lip portion of said female portion operates to retain the ridge portion of said male portion within said female portion.

22. The holster of claim 15, wherein the release mechanism is an air hole extending through a floor portion of barrel portion upon which a bottom surface of the object is seated.

23. The holster of claim 22, wherein release of the object from the barrel portion is accomplished by exerting a force through the air hole upon the bottom surface of the object.
